(19) United States
(12) Patent Application Publication
(10) Pub. No.: US 2017/0090145 A1
(43) Pub. Date: Mar. 30, 2017

(54) DISPLAY DEVICE

(71) Applicant: Coretronic Corporation, Hsin-Chu (TW)

(72) Inventors: Shiuan-Ting Lin, Hsin-Chu (TW); Chuan-Te Cheng, Hsin-Chu (TW); Yi-Chang Chang, Hsin-Chu (TW)

(21) Appl. No.: 14/870,028

(22) Filed: Sep. 30, 2015

(51) Int. Cl. G02B 7/06; G02B 27/01

(52) U.S. Cl. CPC G02B 7/06; G02B 27/0172; G02B 27/0176; G02B 2027/0132; G02B 2027/0154

(57) ABSTRACT

A display device including a display unit and at least one lens module is provided. The at least one lens module includes a first lens barrel, a second lens barrel, at least one lens, and a driving unit. The first lens barrel is connected to the display unit. The second lens barrel includes a barrel body and a rack. The barrel body is screwed with the first lens barrel, and the rack is disposed around the barrel body. The at least one lens is disposed in the barrel body. The driving unit is engaged with the rack. The driving unit is adapted to drive the barrel body to rotate through the rack, such that the second lens barrel moves relatively to the first lens barrel to change a distance between the at least one lens and the display unit.

### BACKGROUND OF THE INVENTION

1. Field of the Invention

The invention generally relates to a display device, and more particularly, to a display device with a lens module.

2. Description of Related Art

The head mounted display (HMD) is one of the key devices in the field regarding the wearable device. By using the head mounted display, the user watches the virtual reality (VR) image displayed by the display panel of the head mounted display.

In detail, the image beam generated from the display panel passes through a lens module in the head mounted display and then arrives eyes of the user. Traditionally, the lens module is driven by a lever to perform focusing while the user apply an external force on the lever, and the lens module has to be locked after the focusing is completed. However, the locking step causes an unexpected movement of the lens module, which decreases the accuracy of focusing and makes the head mounted display inconvenient to be operated.

The information disclosed in the “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention were acknowledged by a person of ordinary skill in the art.

### SUMMARY OF THE INVENTION

The invention is directed to a display device having high accuracy of focusing and is convenient to be operated.

The other purposes and advantages of the invention may be further understood from the technical features of the disclosures of the invention.

For achieving the foregoing at least one of the purposes or the other purposes, in one embodiment of the invention, a display device including a display unit and at least one lens module is provided. The at least one lens module includes a first lens barrel, a second lens barrel, at least one lens, and a driving unit. The first lens barrel is connected to the display unit. The second lens barrel includes a barrel body and a rack. The barrel body is screwed with the first lens barrel, and the rack is disposed around the barrel body. The at least one lens is disposed in the barrel body of the second lens barrel. The driving unit is engaged with the rack. The driving unit is adapted to drive the barrel body to rotate through the rack, such that the second lens barrel adapts to move relatively to the first lens barrel to change a distance between the at least one lens and the display unit.

In one embodiment of the invention, the at least one lens has an optical axis, and the driving unit is adapted to drive the barrel body to rotate by taking an axis parallel to the optical axis as a rotation axis, such that the second lens barrel moves relatively to the first lens barrel along the optical axis.

In one embodiment of the invention, the display device further includes a casing capable of accommodating the display unit and the at least one lens module. The display unit and the first lens barrel are fixed at the casing.

In one embodiment of the invention, the display device further includes a casing capable of accommodating the display unit and the at least one lens module. The driving unit is at least partially located outside the casing.

In one embodiment of the invention, the casing has a slot, and the driving unit is at least partially located outside the casing by passing through the slot.

In one embodiment of the invention, the driving unit is disposed on the first lens barrel.

In one embodiment of the invention, the driving unit includes a driving gear, and the driving gear is engaged with the rack.

In one embodiment of the invention, the driving unit includes a driving gear and an idler gear, and the idler gear is engaged between the driving gear and the rack.

In one embodiment of the invention, the barrel body has an external thread, the first lens barrel has an internal thread, and the barrel body and the first lens barrel are screwed with each other through the external thread and the inner thread.

In one embodiment of the invention, the rack is integrally formed on the barrel body.

In one embodiment of the invention, the display device is a wearable display device.

In one embodiment of the invention, the display unit is a reflective display unit.

In one embodiment of the invention, a number of the at least one lens module is two.

Based on the foregoing descriptions, the embodiments of the invention have at least one of the advantages below. In the display device of the embodiment of the invention, the second lens barrel has a rack and is engaged with the driving unit by the rack. The driving unit is adapted to drive the second lens barrel to rotate through the rack, so as to perform focusing of the lens module. In the embodiment of the invention, after the focusing is completed, the second lens barrel is positioned by the engagement between the rack the driven unit, and thus it is no need to perform a locking step to the lens module after the focusing is completed. Accordingly, an unexpected movement of the lens module caused by the locking step is prevented, such that the accuracy of focusing is increased and the display device is convenient to be operated.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a relation between a display device and an observer according to one embodiment of the invention.

FIG. 1B is a perspective view of a display device according to one embodiment of the invention.

FIG. 2 is a perspective view of partial components of the display device in FIG. 1B from another angle of view.

FIG. 3 is an exploded view of the display device in FIG. 2.

FIG. 4 is a schematic view of partial structure of a display device according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

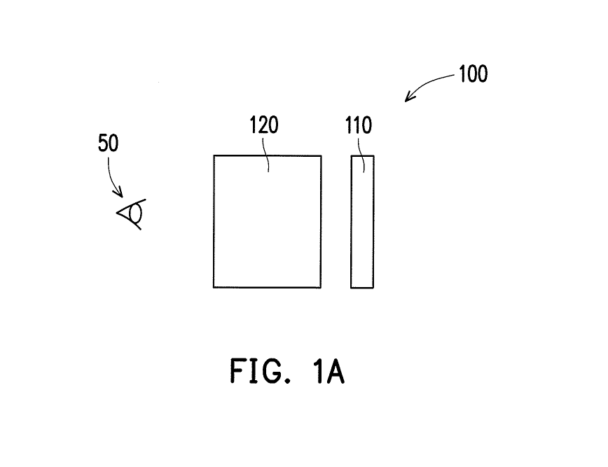

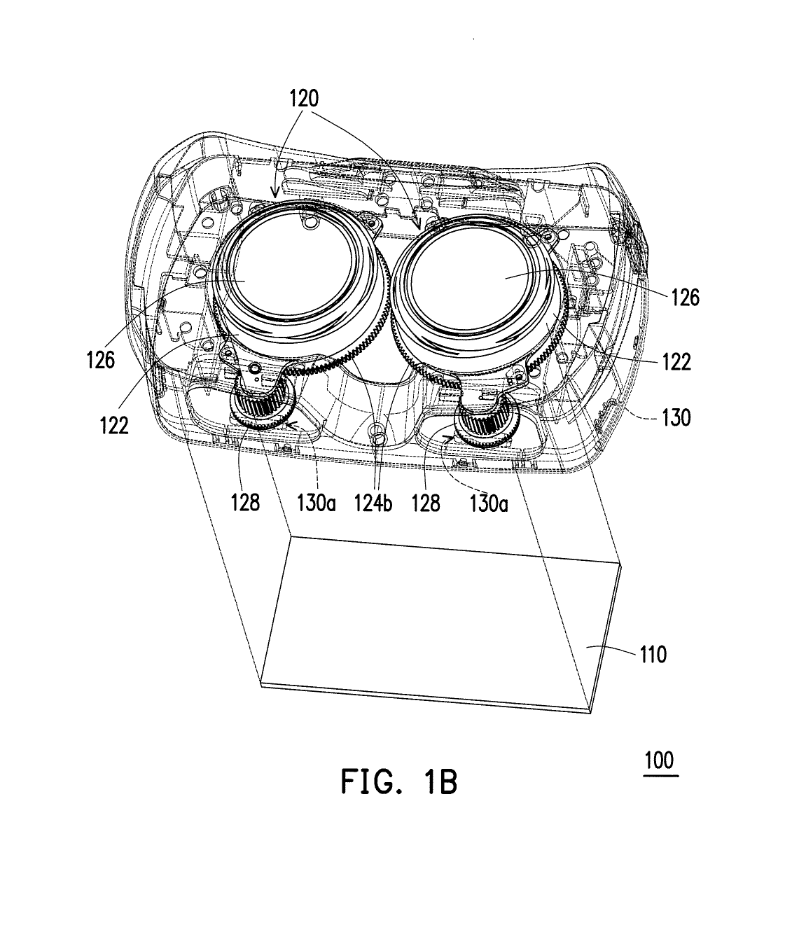

FIG. 1A is a schematic diagram of a relation between a display device and an observer according to one embodiment of the invention. Referring to FIG. 1A, a display device 100 includes a display unit 110 and at least on lens module 120 (one lens module is, for example, illustrated in FIG. 1A). In the embodiment, the lens module 120 is adapted to be corresponding to an observer 50, and the lens(es) in the lens module 120 is(are) disposed between the display unit 110 and the observer 50. However, in the other embodiment, a display device 100 may include two or more lens modules, and the relative details would be described in the following embodiments.

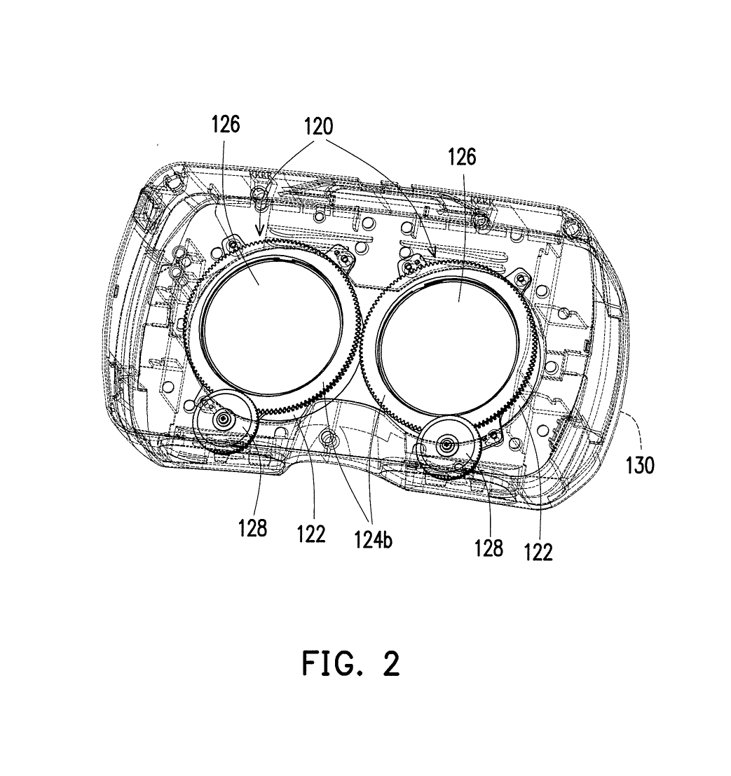

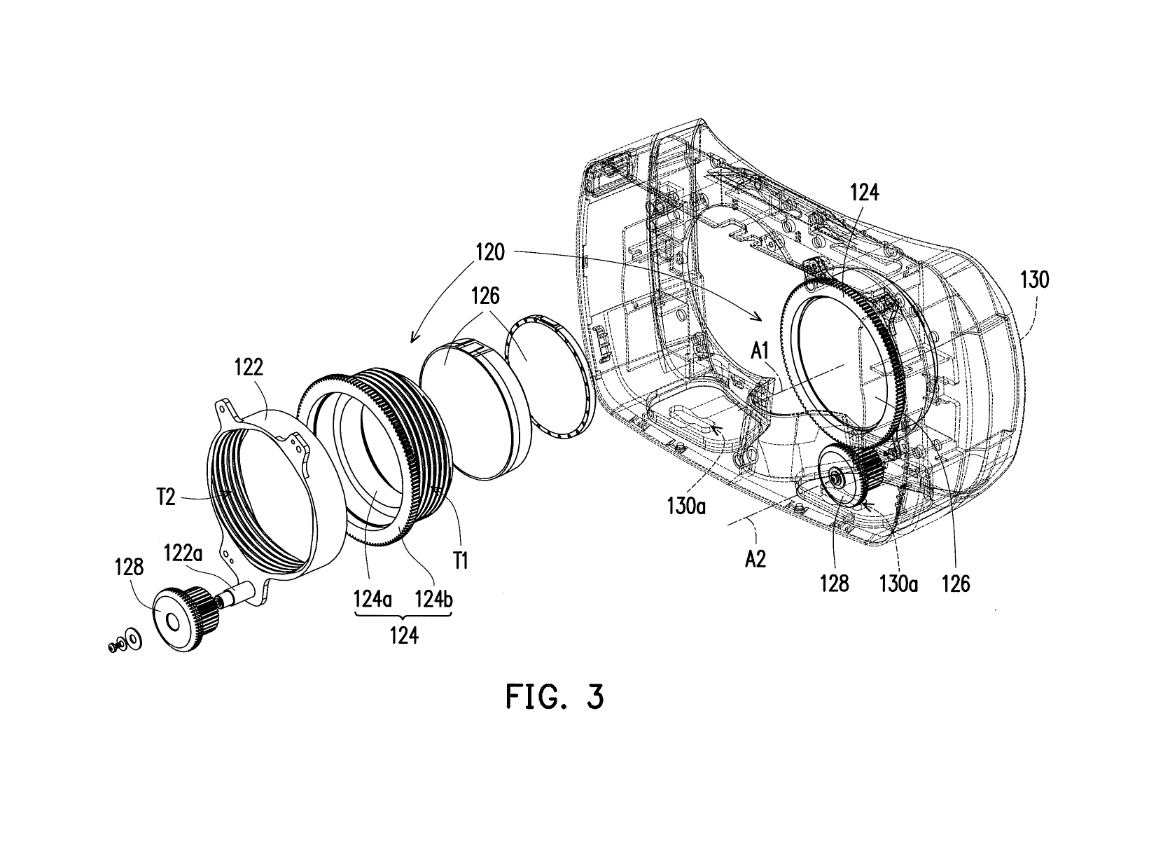

FIG. 1B is a perspective view of a display device according to one embodiment of the invention. FIG. 2 is a perspective view of partial components of the display device in FIG. 1B from another angle of view. FIG. 3 is an exploded view of the display device in FIG. 2. Referring to FIG. 1B to FIG. 3, the display device 100 of the embodiment includes a display unit 110 and two lens modules 120, and the two lens modules 120 of the embodiment are respectively adapted to be corresponding to two eyes of a user. In the embodiment, the image beam provided by the display unit 110 is adapted to pass through the lens modules 120 and then reach the eyes of the user. For clarity's sake, the display unit 110 is illustrated as being separated from the other components in FIG. 1B.

In the embodiment, the display device 100 is, for example, a head mounted display (HMD) or other kinds of wearable display device, and the invention is not limited thereto. In the embodiment, the display unit 110 of the display device 100 is, for example, an active display unit (such as liquid crystal display) or other kinds of reflective/transflective display device (DMD or LCOS device, etc.), and the invention is not limited thereto.

Each of the lens module 120 includes a first lens barrel 122, a second lens barrel 124, at least one lens 126 (two lenses are, for example, illustrated in FIG. 3), and a driving unit 128. The first lens barrel 122 is connected to the display unit 110. The second lens barrel 124 includes a barrel body 124a and a rack 124b disposed around the barrel body 124a. In the embodiment, the rack 124b may be, for example, integrally formed on the barrel body 124a, but the invention is not limited thereto. The lenses 126 are disposed in the barrel body 124a. In the embodiment, the barrel body 124a has an external thread T1, the first lens barrel 122 has an internal thread T2, and the barrel body 124a and the first lens barrel 122 are screwed with each other through the external thread T1 and the inner thread T2. The rack 124b of the second lens barrel 124 is closer to the observer than the first lens barrel 122.

In the embodiment, the driving unit 128 is, for example, a driving gear and is engaged with the rack 124b, and the driving unit 128 is, for example, disposed on a pillar 122a (illustrated in FIG. 3) of the first lens barrel 122. The driving unit 128 is adapted to drive the barrel body 124a to rotate through the rack 124b, such that the second lens barrel 124 moves relatively to the first lens barrel 122 to change a distance between the lenses 126 and the display unit 110, so as to perform focusing of each of the lens modules 120.

In the embodiment, after the focusing is completed, the second lens barrel 124 is positioned by the engagement between the rack 124b and the driven unit 128, and thus it is no need to perform a locking step to each of the lens modules 120 after the focusing is completed. Accordingly, an unexpected movement of each of the lens modules 120 caused by the locking step is prevented, such that the accuracy of focusing is increased and the display device 100 is convenient to be operated.

Specifically, each of the lenses 126 of the embodiment has an optical axis A1 (illustrated in FIG. 3), and the driving unit 128 is adapted to drive the barrel body 124a to rotate by taking an axis A2 (illustrated in FIG. 3) parallel to the optical axis A1 as a rotation axis, such that the second lens barrel 124 moves relatively to the first lens barrel 122 along the optical axis A1.

In the embodiment, the display device 100 further includes a casing 130 capable of accommodating the display unit 110 and the lens modules 120. In the embodiment, the display unit 110 and the first lens barrel 122 are fixed at the casing 130 to be connected to each other. In addition, in the embodiment, the casing 130 may further have two slots 130a, and each of the driving units 128 is at least partially located outside the casing 130 by passing through the corresponding slot 130a, such that the user may apply force on each of the driving units 128 to make the driving units 128 rotate.

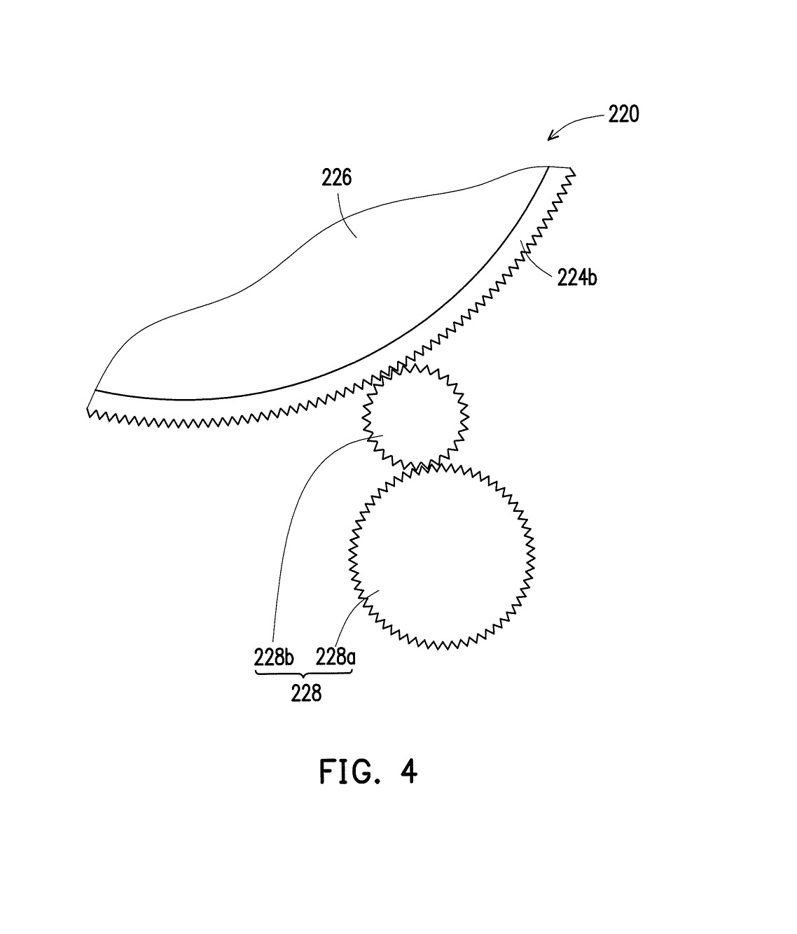

FIG. 4 is a schematic view of partial structure of a display device according to another embodiment of the invention. In the lens module 220 of the embodiment illustrated in FIG. 4, arrangement and operation of the rack 224b, the lens 226, and the driving unit 228 are similar to arrangement and operation of the rack 124b, the lens 126, and the driving unit 128 illustrated in FIG. 1B, FIG. 2 to FIG. 3. The major difference between the lens module 120 and the lens module 220 is that, the driving unit 228 further includes a driving gear 228a and an idler gear 228b, and the idler gear 228b is engaged between the driving gear 228a and the rack 224b. By arrangement of the idler gear 228b, disposing position of the driving gear 228a is more flexibility to conform entire design of the lens module 220.

In summary, the embodiments of the invention have at least one of the advantages below. In the display device of the embodiment of the invention, the second lens barrel has a rack and is engaged with the driving unit by the rack. The driving unit is adapted to drive the second lens barrel to rotate through the rack, so as to perform focusing of the lens module. In the embodiment of the invention, after the focusing is completed, the second lens barrel is positioned by the engagement between the rack the driven unit, and thus it is no need to perform a locking step to the lens module after the focusing is completed. Accordingly, an unexpected movement of the lens module caused by the locking step is prevented, such that the accuracy of focusing is increased and the display device is convenient to be operated.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display device, comprising:
a display unit; and
at least one lens module, comprising:
a first lens barrel, connected to the display unit;
a second lens barrel, comprising a barrel body and a rack, wherein
the barrel body is screwed with the first lens barrel, and the rack is disposed around the barrel body;
at least one lens, disposed in the barrel body of the second lens barrel; and
a driving unit, engaged with the rack, wherein the driving unit is adapted to drive the barrel body to rotate through the rack, such that the second lens barrel adapts to move relatively to the first lens barrel to change a distance between the at least one lens and the display unit.

2. The display device as claimed in claim 1, wherein the at least one lens has an optical axis, and the driving unit is adapted to drive the barrel body to rotate by taking an axis parallel to the optical axis as a rotation axis, such that the second lens barrel moves relatively to the first lens barrel along the optical axis.

3. The display device as claimed in claim 1, further comprising a casing capable of accommodating the display unit and the at least one lens module, wherein the display unit and the first lens barrel are fixed at the casing.

4. The display device as claimed in claim 1, further comprising a casing capable of accommodating the display unit and the at least one lens module, wherein the driving unit is at least partially located outside the casing.

5. The display device as claimed in claim 4, wherein the casing has a slot, and the driving unit is at least partially located outside the casing by passing through the slot.

6. The display device as claimed in claim 1, wherein the driving unit is disposed on the first lens barrel.

7. The display device as claimed in claim 1, wherein the driving unit comprises a driving gear, and the driving gear is engaged with the rack.

8. The display device as claimed in claim 1, wherein the driving unit comprises a driving gear and an idler gear, and the idler gear is engaged between the driving gear and the rack.

9. The display device as claimed in claim 1, wherein the barrel body has an external thread, the first lens barrel has an internal thread, and the barrel body and the first lens barrel are screwed with each other through the external thread and the inner thread.

10. The display device as claimed in claim 1, wherein the rack is integrally formed on the barrel body.

11. The display device as claimed in claim 1, wherein the display device is a wearable display device.

12. The display device as claimed in claim 1, wherein the display unit is a reflective display unit.

13. The display device as claimed in claim 1, wherein a number of the at least one lens module is two.
